(19) United States
(12) Patent Application Publication
(10) Pub. No.: US 2013/0110394 A1
(43) Pub. Date: May 2, 2013

(54) NAVIGATION SYSTEM

(71) Applicants: Takashi Irie, Tokyo (JP); Kumi Nishibashi, Tokyo (JP)

(72) Inventors: Takashi Irie, Tokyo (JP); Kumi Nishibashi, Tokyo (JP)

(73) Assignee: MITSUBISHI ELECTRIC CORPORATION, Tokyo (JP)

(21) Appl. No.: 13/809,488

(22) PCT Filed: Aug. 23, 2010
(86) PCT No.: PCT/JP2010/005181

§ 371 Date: Jan. 10, 2013

(51) Int. Cl. G01C 21/26

(52) U.S. Cl. CPC G01C 21/26
USPC 701/461

(57) ABSTRACT

A navigation system includes a map data acquiring unit for acquiring map data defining two types of lanes, shifting between which is regulated, in a single link; a driving link deciding unit for identifying a link of a driving lane of a vehicle according to the map data acquired by the map data acquiring unit and according to position information about the vehicle; a freeway infrastructure acquiring unit for acquiring, from node information of the map data, freeway infrastructure data indicating a freeway infrastructure which is accessible by the vehicle from the driving lane including the link identified by the driving link deciding unit; a freeway infrastructure storage unit for storing the freeway infrastructure data acquired by the freeway infrastructure acquiring unit; and a freeway infrastructure display unit for displaying the freeway infrastructure data stored in the freeway infrastructure storage unit.

### TECHNICAL FIELD

The present invention relates to a navigation system for guiding a user to a destination, and particularly to a technique for informing a user of a freeway infrastructure such as an exit or service area of a freeway.

### BACKGROUND ART

Conventionally, as a road that regulates a drive of a vehicle, an HOV (High-Occupancy Vehicle) lane is known which is employed in a road system mainly seen in large cities in North America, for example. An HOV lane, which is also called a car-pool lane, is a lane that permits only a vehicle with two or more passengers to travel, and is known as a lane juxtaposed with a freeway or as a lane taking a shortcut across an interchange. A road system employing the HOV lane intends to relieve traffic congestion by reducing total traffic by encouraging two or more passengers to get on a single vehicle by giving preferential treatment to them of being able to arrive at a destination within a shorter period by traveling through the HOV lane.

On the other hand, as one of the functions of a navigation system, a function is known which displays, while driving on a freeway, information about freeway infrastructure such as an exit of the freeway or service area ahead of the vehicle in ascending order of distance from the vehicle in a list format (referred to as a “list display” from now on). In this case, freeway infrastructure to be displayed is extracted along a route when the route is drawn, but is extracted, when the route is not drawn, by pulling the freeway on which the vehicle is running to this side along the road.

When shifting is regulated between lanes such as between an HOV lane and an ordinary lane (lane other than an HOV lane), a freeway is represented in conventional map data as a separate link even if they exist on the same road, or the data about the HOV lane is not shown. Accordingly, the navigation system can distinguish between the HOV lane and ordinary lane on which the route searched for is drawn, and can recognize which one of the HOV lane and ordinary lane the vehicle matches. Therefore, it can extract freeway infrastructure for the HOV lane and freeway infrastructure for the ordinary lane separately.

As a technique relevant to such an HOV lane, Patent Document 1 discloses a navigation system that searches for a route by using information about the HOV lane as road information about the route to a destination a user sets. To efficiently drive along a lane that limits shifting to or from another lane, the navigation system reads map data containing road information about entry/departure points on a freeway having the HOV lane from a DVD (Digital Versatile Disk) and stores in a data buffer. A route search processing unit carries out route search processing while considering whether the HOV lane can be used or not by using the map data stored in the data buffer. To carryout route guidance using the HOV lane, an HOV lane guide unit gives prescribed lane shift guidance with an image and voice at timing when an entry/departure point at which the vehicle should change the course comes within a prescribed distance from the vehicle.

### Prior Art Document

### Patent Document

Patent Document 1: Japanese Patent Laid-Open No. 2001-183159.

Recently, however, map data has been prepared which represents an HOV lane and an ordinary lane as a single link when they exist on the same road. As a result, extracting freeway infrastructure by simply pulling the route or road on which the vehicle is running to this side along the road has a problem in that freeway infrastructure of both the HOV lane and ordinary lane are extracted and displayed in a list.

Therefore, while the vehicle is running along the HOV lane, for example, a list of a freeway exit or service area is displayed to which the vehicle cannot actually approach from the HOV lane, and hence the user cannot decide an accessible freeway infrastructure in practice, offering a problem of bringing about confusion.

The present invention is implemented to solve the foregoing problem. Therefore it is an object of the present invention to provide a navigation system capable of presenting an actually accessible freeway infrastructure clearly.

### DISCLOSURE OF THE INVENTION

A navigation system in accordance with the present invention comprises: a map data acquiring unit for acquiring map data defining two types of lanes, shifting between which is regulated, in a single link; a driving link deciding unit for identifying a link of a driving lane of a vehicle according to the map data acquired by the map data acquiring unit and according to position information about the vehicle; a freeway infrastructure acquiring unit for acquiring, from node information of the map data freeway infrastructure data indicating a freeway infrastructure which is accessible by the vehicle from the driving lane including the link identified by the driving link deciding unit; a freeway infrastructure storage unit for storing the freeway infrastructure data acquired by the freeway infrastructure acquiring unit; and a freeway infrastructure display unit for displaying the freeway infrastructure data stored in the freeway infrastructure storage unit.

According to the navigation system in accordance with the present invention, it can provide the user with an actually accessible freeway infrastructure clearly.

### BRIEF DESCRIPTION OF THE DRAWINGS

FIG. 1 is a block diagram showing a hardware configuration of a navigation system of an embodiment 1 in accordance with the present invention;

FIG. 2 is a diagram showing map data used in the navigation system of the embodiment 1 in accordance with the present invention;

FIG. 3 is a view showing an example of information about freeway infrastructure displayed on the navigation system of the embodiment 1 in accordance with the present invention;

FIG. 4 is a functional block diagram showing a functional configuration of the control unit in the navigation system of the embodiment 1 in accordance with the present invention;

FIG. 5 is a diagram showing an example of freeway infrastructure data used in the navigation system of the embodiment 1 in accordance with the present invention;

FIG. 6 is a flowchart for explaining the operation of the navigation system of the embodiment 1 in accordance with the present invention;

FIG. 7 is a flowchart for explaining a variation of the operation of the navigation system of the embodiment 1 in accordance with the present invention;

FIG. 8 is a diagram showing an example of avoiding redundant display of an exit in the navigation system of the embodiment 1 in accordance with the present invention;

FIG. 9 is a diagram showing a variation of the operation of the navigation system of the embodiment 1 in accordance with the present invention;

FIG. 10 is a flowchart for explaining the operation of a navigation system of an embodiment 2 in accordance with the present invention;

FIG. 11 is a diagram showing map data used in the navigation system of the embodiment 2 in accordance with the present invention; and

FIG. 12 is a diagram showing a display example of freeway infrastructure in the navigation system of the embodiment 2 in accordance with the present invention.

### BEST MODE FOR CARRYING OUT THE INVENTION

The best mode for carrying out the invention will now be described with reference to the accompanying drawings to explain the present invention in more detail. Incidentally, the following description will be made by way of example having two types of lanes of “HOV lane” and “ordinary lane”, shifting between which is regulated.

### EMBODIMENT 1

The navigation system of the embodiment 1 in accordance with the present invention is configured in such a manner as to guide a user to a freeway infrastructure by using map data representing an HOV lane and ordinary lane in a single link. Incidentally, the term “freeway infrastructure accessible from a driving lane” mentioned in the present invention refers to an infrastructure dedicated to the lane such as an exit or a service area of the freeway mentioned above.

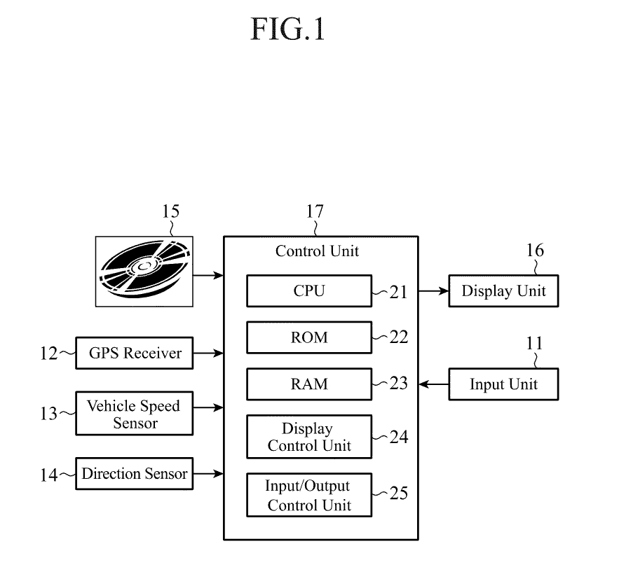

FIG. 1 is a block diagram showing a hardware configuration of the navigation system of the embodiment 1 in accordance with the present invention. The navigation system comprises an input unit 11, a GPS (Global Positioning System) receiver 12, a vehicle speed sensor 13, a direction sensor 14, a map data storage unit 15, a display unit 16 and a control unit 17.

The input unit 11 consists of a touch screen mounted on the screen of the display unit 16, for example. The input unit 11 is used, for example, to set a starting point, a destination and passing places for a route search, or to provide various instructions to the navigation system from a user. The information input from the input unit 11 is delivered to the control unit 17 as an operation signal.

The GPS receiver 12 detects the present position of the vehicle with the navigation system in response to GPS signals received from GPS satellites not shown. The present position of the vehicle detected by the GPS receiver 12 is delivered to the control unit 17 as a present position signal. The vehicle speed sensor 13 detects the moving speed of the vehicle. The moving speed detected with the vehicle speed sensor 13 is delivered to the control unit 17 as a speed signal. The direction sensor 14 detects the direction of the vehicle. The direction detected with the direction sensor 14 is delivered to the control unit 17 as a direction signal.

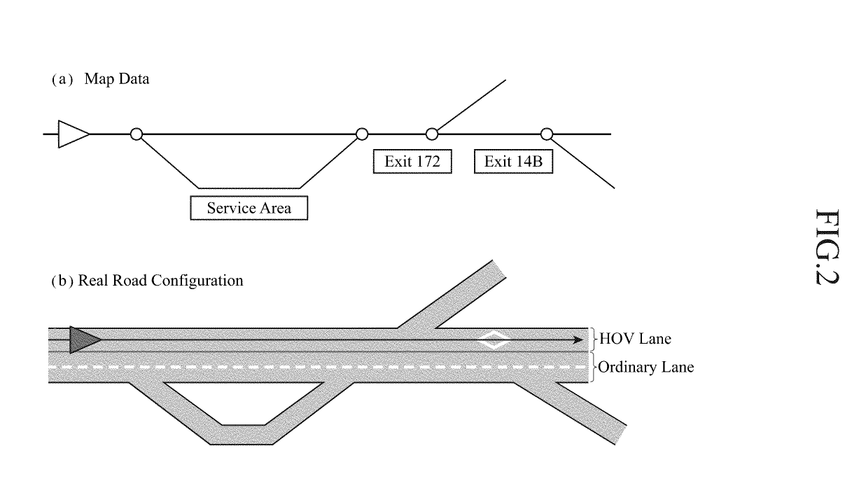

The map data storage unit 15, which consists of an HDD (Hard Disk Drive), for example, stores digitized map data containing road network data defining roads with links and nodes. For example, as shown in FIG. 2(b), when an ordinary lane and an HOV lane run side by side and are separated by a painted line like a yellow line without any other physical division, the ordinary lane and HOV lane are expressed as road network data representing a single road rather than separate roads as shown in FIG. 2(a). Incidentally, as the map data storage unit 15, not only the HDD but also a disk drive for reading data from a DVD or CD (Compact Disc) loaded thereon, a USB memory or an SD card can be used.

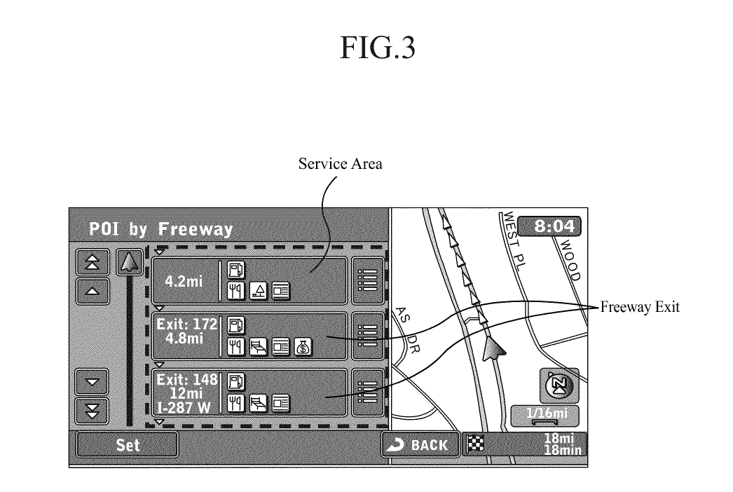

The display unit 16, which consists of an LCD (Liquid Crystal Display), for example, displays on its screen a map, a route, information about freeway infrastructure and various guide messages in response to a video signal delivered from the control unit 17. FIG. 3 shows an example that displays a map on the right of the screen and information about freeway infrastructure on the left of the screen. The information about freeway infrastructure contains one service area and two freeway exits.

The control unit 17 controls the whole navigation system. The control unit 17 comprises a CPU (Central Processing Unit) 21, a ROM (Read Only Memory) 22, a RAM (Random Access Memory) 23, a display control unit 24 and an input/output control unit 25.

The CPU 21 executes processing for route search, route guidance or the like by using the RAM 23 as a work memory and by operating in accordance with a program read out of the ROM 22. The ROM 22 stores programs and data which are read by the CPU 21 to execute various processing. The RAM 23 is used as the work memory of the CPU 21 as mentioned above, and temporarily stores data (such as map data developed) during arithmetic processing.

The display control unit 24 controls the display unit 16. To be concrete, the display control unit 24 converts the display data created by the CPU 21 to a video signal, and delivers it to the display unit 16 via the input/output control unit 25. The input/output control unit 25 functions as an interface between the control unit 17 and the input unit 11, GPS receiver 12, vehicle speed sensor 13, direction sensor 14, map data storage unit 15 and display unit 16, which are connected to the control unit 17, and controls transmission and reception of the signals between them.

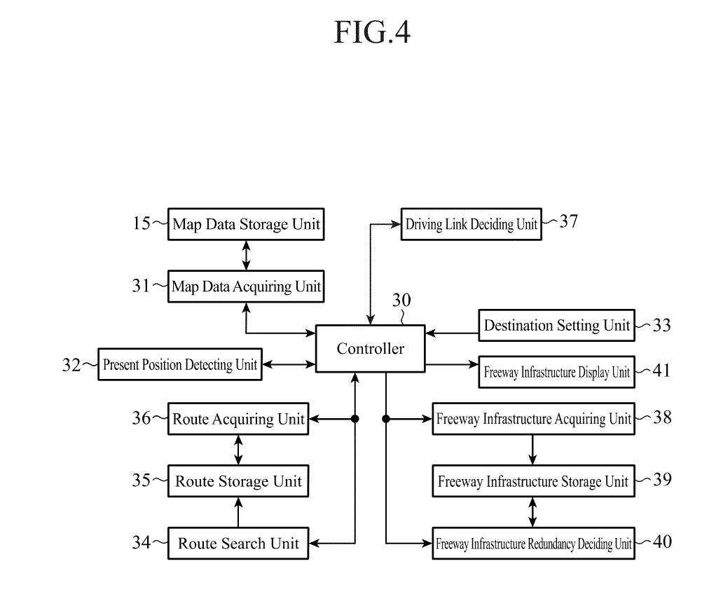

Next, details of the functions implemented by the control unit 17 will be described. FIG. 4 is a block diagram showing a functional configuration of the control unit 17. The control unit 17 comprises a controller 30, a map data acquiring unit 31, a present position detecting unit 32, a destination setting unit 33, a route search unit 34, a route storage unit 35, a route acquiring unit 36, a driving link deciding unit 37, a freeway infrastructure acquiring unit 38, a freeway infrastructure storage unit 39, a freeway infrastructure redundancy deciding unit 40 and a freeway infrastructure display unit 41. These components are implemented by the program processing executed by the CPU 21 except for the route storage unit 35 and freeway infrastructure storage unit 39.

The controller 30 controls the whole control unit 17. More specifically, the controller 30 controls start and stop of the plurality of components connected thereto (map data acquiring unit 31, present position detecting unit 32, destination setting unit 33, route search unit 34, route acquiring unit 36, driving link deciding unit 37, freeway infrastructure acquiring unit 38, freeway infrastructure redundancy deciding unit 40 and freeway infrastructure display unit 41) and data exchange between them.

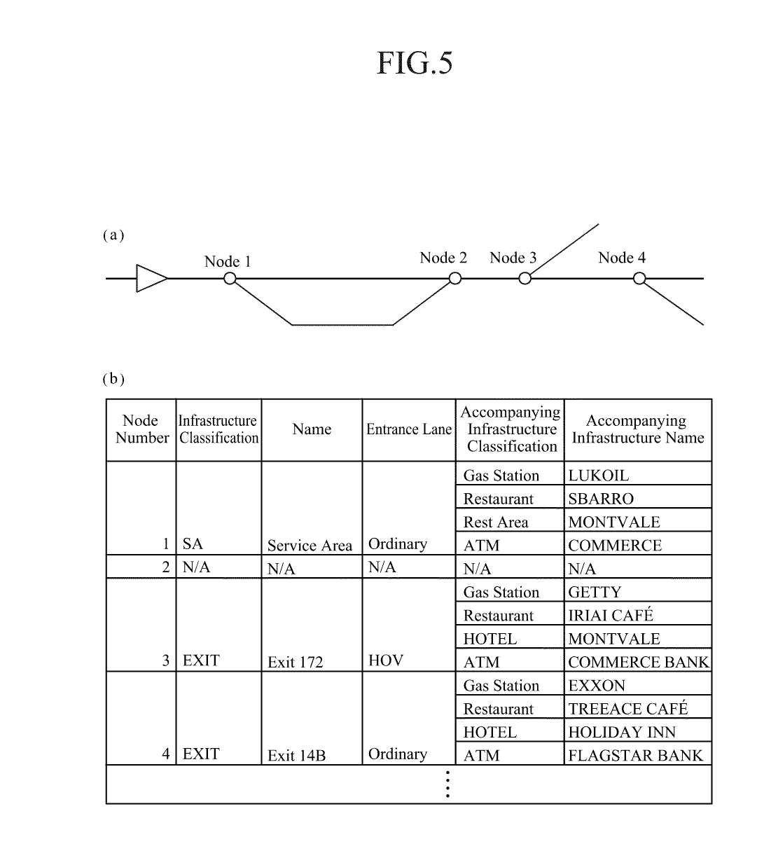

The map data acquiring unit 31 acquires map data from the map data storage unit 15. The map data contains the road network data and freeway infrastructure data. FIG. 5 is a diagram showing an example of the freeway infrastructure data. The freeway infrastructure data comprises the following data: “node number” assigned to each node on the road network data; “infrastructure classification” indicating whether a freeway infrastructure is a service area (SA) or freeway exit (EXIT); “name” indicating the name of a freeway infrastructure; “entrance lane” indicating a lane enabling access to a freeway infrastructure; “accompanying infrastructure classification” indicating kinds of accompanying infrastructure near the freeway infrastructure; and “accompanying infrastructure name” indicating the name of an accompanying infrastructure. The map data acquired by the map data acquiring unit 31 is delivered to the controller 30.

The present position detecting unit 32 detects the present position of the vehicle from the present position signal delivered from the GPS receiver 12 or the present position signal generated by dead reckoning using the direction signal delivered from the direction sensor 14 and the speed signal delivered from the vehicle speed sensor 13, and the map data acquired from the map data acquiring unit 31 via the controller 30. The present position of the vehicle detected by the present position detecting unit 32 is delivered to the controller 30 as vehicle position information. Incidentally, since the data exchange between the components connected to the controller 30 are all carried out via the controller 30, the description of “via controller 30” may be omitted in some cases.

The destination setting unit 33 acquires the data designating a destination from the operation signal delivered from the input unit 11, and sends it to the controller 30 as the destination data.

The route search unit 34 searches for a route from the starting point, which is the present position indicated by the vehicle position information from the present position detecting unit 32, to the destination indicated by the destination data from the destination setting unit 33 in accordance with the map data acquired from the map data acquiring unit 31 . The route searched by the route search unit 34 is delivered to the route storage unit 35 as the route data. Incidentally, as for the starting point, a configuration is also possible which inputs it from the input unit 11.

The route storage unit 35, which is placed on a part of the RAM 23 included in the control unit 17, for example, stores the route data delivered from the route search unit 34. The route data retained in the route storage unit 35 is read out by the route acquiring unit 36.

The route acquiring unit 36 reads the route data out of the route storage unit 35 in response to a request from the controller 30 and delivers it to the controller 30.

The driving link deciding unit 37 decides on whether the driving link, which is identified by the present position indicated by the vehicle position information from the present position detecting unit 32 and by the road network data contained in the map data acquired from the map data storage unit 15 by the map data acquiring unit 31, is a freeway or not. The decision result by the driving link deciding unit 37 is delivered to the controller 30.

The freeway infrastructure acquiring unit 38 recognizes that when a freeway infrastructure at a node ahead of the vehicle is accessible, the freeway infrastructure is a subject to be displayed, and causes the freeway infrastructure storage unit 39 to store the freeway infrastructure data (see FIG. 5). The freeway infrastructure storage unit 39 stores the freeway infrastructure to be displayed, that is, to be more specific, the freeway infrastructure data delivered from the freeway infrastructure acquiring unit 38.

The freeway infrastructure redundancy deciding unit 40 decides on whether the freeway infrastructure data stored in the freeway infrastructure storage unit 39 contains a plurality of freeway infrastructure data including the same accompanying infrastructure, and deletes, when deciding that it contains a plurality of the freeway infrastructure data, the freeway infrastructure data except one of them.

The freeway infrastructure display unit 41 creates the display data for causing the display unit 16 to display information relating to the freeway infrastructure indicated by the freeway infrastructure data acquired by the freeway infrastructure acquiring unit 38. The display data created by the freeway infrastructure display unit 41 is delivered to the display control unit 24 in the control unit 17.

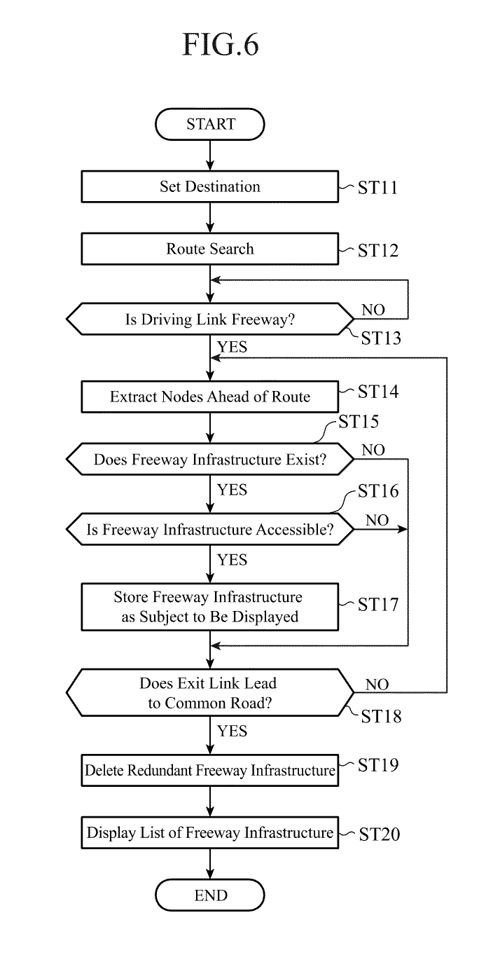

Next, the operation of the navigation system of the embodiment 1 in accordance with the present invention with the foregoing configuration will be described with reference to the flowchart shown in FIG. 6, centering on the freeway infrastructure display processing for displaying the freeway infrastructure.

In the freeway infrastructure display processing, a destination setting is carried out, first (step ST11). Specifically, the route search unit 34 acquires the destination data delivered from the destination setting unit 33.

Subsequently, the route search is carried out (step ST12). Specifically, the route search unit 34 searches for the route from the starting point, which is the present position indicated by the vehicle position information from the present position detectingunit 32, to the destination indicated by the destination data from the destination setting unit 33 in accordance with the map data from the map data acquiring unit 31. The route searched by the route search unit 34 is delivered to the route storage unit 35 and stored as the route data.

Subsequently, a check is made whether the driving link is a freeway or not (step ST13). Specifically, the driving link deciding unit 37 identifies the driving link according to the present position indicated by the vehicle position information from the present position detecting unit 32 and according to the road network data contained in the map data acquired from the map data storage unit 15 by the map data acquiring unit 31, and checks whether the link is a freeway or not.

If a decision is made at this step ST13 that the driving link is not a freeway, the system recognizes that it is not yet timing to display the list of the freeway infrastructure, and enters standby mode while executing the step ST13 repeatedly.

When making a decision in the standby mode, which executes the foregoing step ST13 repeatedly, that the driving link is a freeway, the system recognizes that the vehicle enters the freeway, and then extracts a node ahead on the route (step ST14). Specifically, the freeway infrastructure acquiring unit 38 acquires the route data read out of the route storage unit 35 by the route acquiring unit 36, and acquires the node data ahead of the vehicle on the route from the route data acquired.

Subsequently, a check is made whether a freeway infrastructure exists or not (step ST15). Specifically, the freeway infrastructure acquiring unit 38 checks whether the freeway infrastructure exists at the node indicated by the node data acquired at step ST14 by referring to the freeway infrastructure data (see FIG. 5). When a decision is made at step ST15 that no freeway infrastructure is present, the sequence proceeds to step ST18.

On the other hand, if a decision is made at step ST15 that a freeway infrastructure is present, then a check is made whether the freeway infrastructure is accessible or not (step ST16). Specifically, the freeway infrastructure acquiring unit 38 checks whether the freeway infrastructure at the node indicated by the node data acquired at step ST14 is accessible from the route or not. To be concrete, the freeway infrastructure acquiring unit 38 compares the “entrance lane” of the freeway infrastructure data with the lane information of the route data flowing into the node, and checks whether the types of both lanes agree or not. If a decision is made at this step ST16 that the freeway infrastructure is not accessible, that is, the types of both lanes do not agree, the sequence proceeds to step ST18.

On the other hand, if a decision is made at step ST16 that the freeway infrastructure is accessible, that is, that the types of both lanes agree with each other, then the freeway infrastructure is stored as a subject to be displayed (step ST17). Specifically, the freeway infrastructure acquiring unit 38 stores the freeway infrastructure data in the freeway infrastructure storage unit 39 (see FIG. 5). After that, the sequence proceeds to step ST18.

At step ST18, a check is made whether the exit link of the node leads to a common road or not. Specifically, the freeway infrastructure acquiring unit 38 checks whether the exit link of the node indicated by the node data acquired at step ST14 leads to a common road or not. If a decision is made at this step ST18 that the exit link of the node does not lead to the common road, it is recognized that the freeway continues, and the sequence returns to step ST14 to repeat the foregoing processing to acquire the freeway infrastructure data ahead of the node.

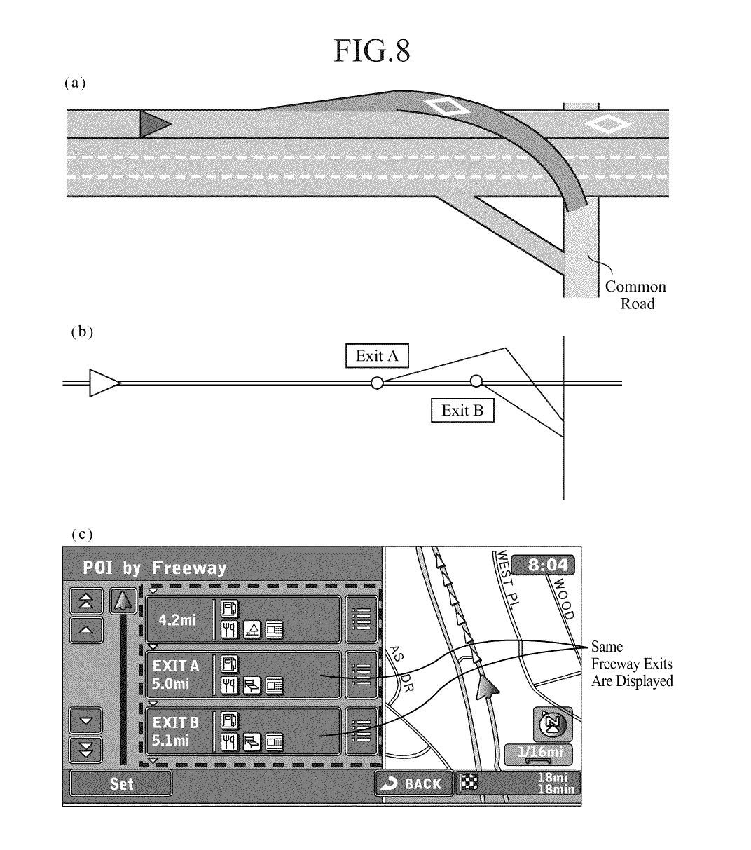

On the other hand, if a decision is made step ST18 that the exit link of the node leads to the common road, it is recognized that the acquisition of the freeway infrastructure data to the end of the freeway has been completed, followed by deleting redundant freeway infrastructure (step ST19). Specifically, if a plurality pieces of freeway infrastructure data containing the same accompanying infrastructure are present in the freeway infrastructure data stored at step ST17, the freeway infrastructure redundancy deciding unit 40 deletes all the other freeway infrastructure data except one of them. This makes it possible to avoid a state as shown in FIG. 8, for example, in which the freeway exit leading from an HOV lane to a common road and the freeway exit leading from an ordinary lane to the common road are displayed redundantly.

Subsequently, the freeway infrastructure is displayed in a list (step ST20). Specifically, the freeway infrastructure display unit 41 displays the freeway infrastructure indicated by the freeway infrastructure data stored in the freeway infrastructure storage unit 39 on the navigation screen in a list format.

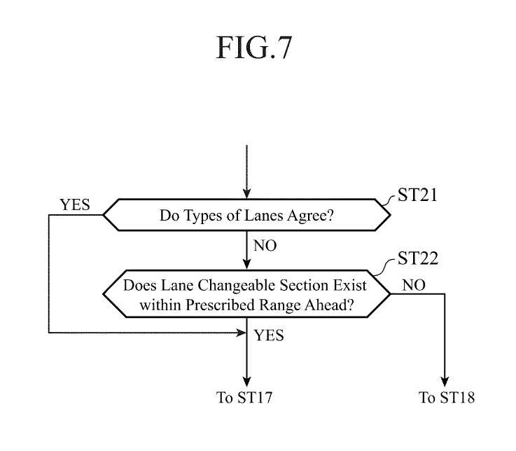

Incidentally, the processing at the foregoing step ST16 can be replaced by the processing shown in FIG. 7. In this processing, a check is made whether the types of the lanes agree or not (step ST21). Specifically, the freeway infrastructure acquiring unit 38 checks whether the freeway infrastructure of the node indicated by the node data acquired at step ST14 is accessible from the route or not. To be concrete, the freeway infrastructure acquiring unit 38 compares the “entrance lane” of the freeway infrastructure data with the lane information of the route data entering the node, and checks whether the two lanes have the same type or not. If a decision is made at this step ST21 that their types agree with each other, it is recognized that the freeway infrastructure is accessible, and the sequence proceeds to step ST17.

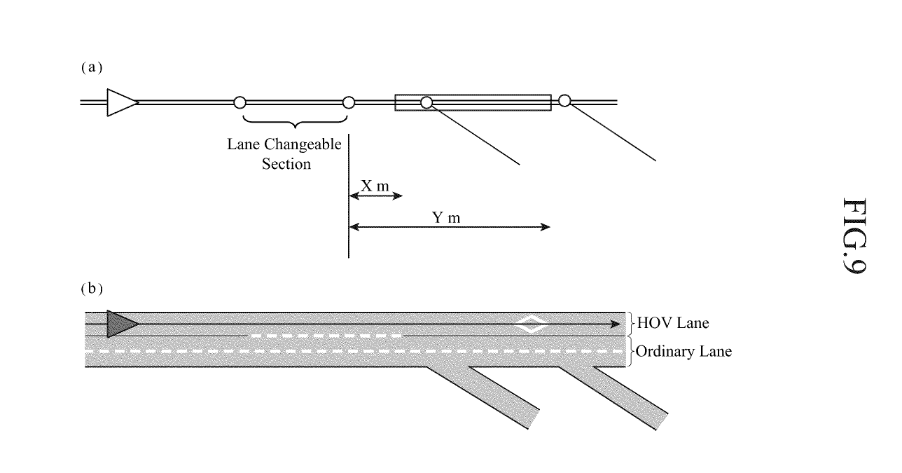

On the other hand, if a decision is made at step ST21 that the types of the two lanes disagree, it is recognized that the freeway infrastructure is not accessible, followed by checking whether there is a lane changeable section ahead within a prescribed range (step ST22). Specifically, the freeway infrastructure acquiring unit 38 acquires the route data read out of the route storage unit 35 by the route acquiring unit 36, and checks in accordance with the route data acquired whether a lane changeable section is present on the route within a prescribed range not less than X m (X=800 m, for example) and not greater than Y m (Y=2000 m, for example) from the node as shown in FIG. 9. If a decision is made at step ST22 that a lane changeable section is present within the prescribed range ahead, it is recognized that the freeway infrastructure is accessible and the sequence proceeds to step ST17. On the other hand, a decision is made at step ST22 that a lane changeable section is not present within the prescribed range ahead, it is recognized that the freeway infrastructure is not accessible, and the sequence proceeds to step ST18.

As described above, according to the navigation system of the embodiment 1 in accordance with the present invention, it can provide a user with an actually accessible freeway infrastructure clearly even when using the map data representing the HOV lane and ordinary lane in a single link.

### EMBODIMENT 2

The navigation system of an embodiment 2 in accordance with the present invention is configured in such a manner as to guide a user to a freeway infrastructure using map data that represents an HOV lane and an ordinary lane in separate links (in two links).

A configuration of the navigation system of the embodiment 2 is the same as that of the foregoing embodiment 1 except for the structure of the map data stored in the map data storage unit 15. Specifically, when the ordinary lane and HOV lane run side by side, the road network data contained in the map data is represented as two roads. The following description will be made, centering on the operation of the navigation system.

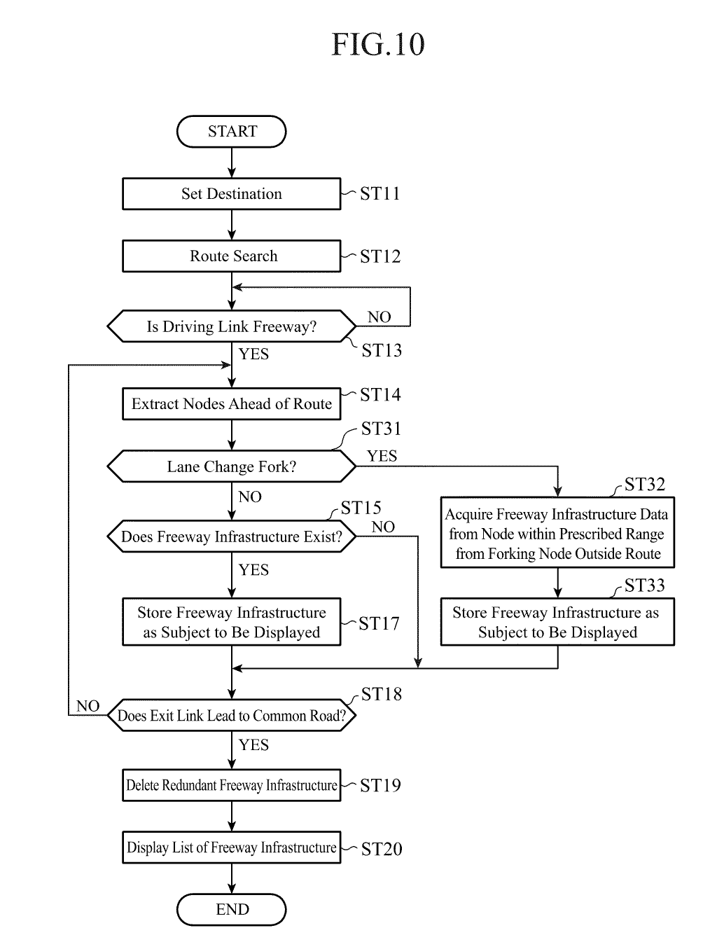

FIG. 10 is a flowchart showing the operation of the navigation system of the embodiment 2, centering on the freeway infrastructure display processing for displaying freeway infrastructure. In the following description, steps of executing the same processing as those of the navigation system of the embodiment 1 shown in the flowchart of FIG. 6 are designated by the same reference symbols as those of FIG. 6 and their description will be omitted.

In the freeway infrastructure display processing, the destination setting is carried out, first (step ST11). Subsequently, the route search is carried out (step ST12). Then, a check is made whether the driving link is a freeway or not (step ST13). If a decision is made at this step ST13 that the driving link is not a freeway, the system recognizes that it is not yet timing to display the list of the freeway infrastructure, and enters standby mode while executing the step ST13 repeatedly.

When making a decision in the standby mode, which executes the foregoing step ST13 repeatedly, that the driving link is a freeway, the system recognizes that the vehicle enters the freeway, and then extracts a node ahead on the route (step ST14).

Subsequently, a check is made whether the node extracted at step ST14 is a lane change fork (step ST31). Specifically, the freeway infrastructure acquiring unit 38 checks whether the node is the point at which the lane is changed or not. If a decision is made at step ST31 that the node is not the lane change fork, then a check is made whether a freeway infrastructure is present or not (step ST15). If a decision is made at step ST15 that no freeway infrastructure is present, the sequence proceeds to step ST18.

On the other hand, if a decision is made at step ST15 that a freeway infrastructure is present, then the freeway infrastructure is stored as a subject to be displayed (step ST17). After that, the sequence proceeds to step ST18.

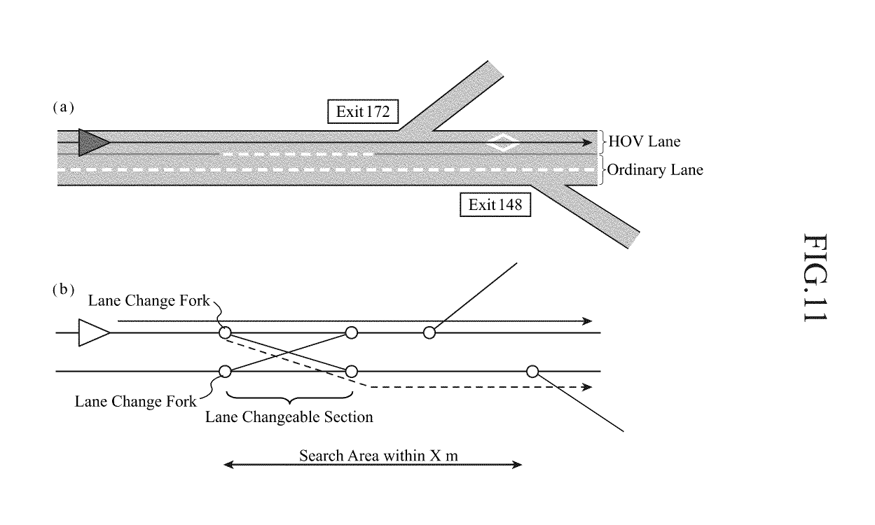

If a decision is made at the foregoing step ST31 that the node is a lane change fork, then the freeway infrastructure data is acquired from a node within a prescribed range from the lane change fork (referred to as a “forking node” from now on) (step ST32). Specifically, as shown in FIG. 11, the freeway infrastructure acquiring unit 38 pulls the freeway link outside the route from the forking node, which is the start point of the lane changeable section, to this side by X m (X=2000 m, for example) along the traveling direction, and acquires the freeway infrastructure data from a node (inclusive of the forking node) within the range.

Subsequently, the freeway infrastructure is stored (step ST33). Specifically, the freeway infrastructure acquiring unit 38 stores the freeway infrastructure data acquired at step ST32 in the freeway infrastructure storage unit 39. After that, the sequence proceeds to step ST18.

At step ST18, a checked is made whether the exit link of the node leads to a common road or not. If a decision is made at this step ST18 that the exit link of the node does not lead to the common road, it is recognized that the freeway continues, and the sequence returns to step ST14 to repeat the foregoing processing to acquire the information about freeway infrastructure ahead of the node.

On the other hand, if a decision is made step ST18 that the exit link of the node leads to the common road, it is recognized that the acquisition of the freeway infrastructure data to the end of the freeway has been completed, followed by deleting redundant freeway infrastructure (step ST19). This makes it possible to avoid a state as shown in FIG. 8, for example, in which the freeway exit leading from an HOV lane to a common road and the freeway exit leading from an ordinary lane to the common road are displayed redundantly.

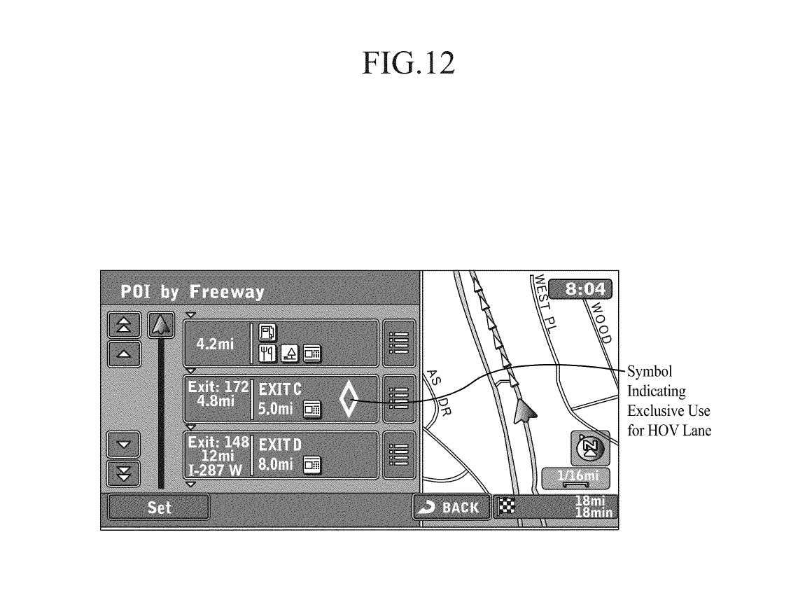

Subsequently, the freeway infrastructure is displayed in a list (step ST20). At this time, a configuration is also possible which displays an icon (symbol) as shown in FIG. 12, which indicates that the freeway infrastructure is accessible only from the HOV lane, by referring to the “entrance lane” information of the freeway infrastructure data.

As described above, according to the navigation system of the embodiment 2 in accordance with the present invention, it can provide a user with an actually accessible freeway infrastructure clearly even when the map data is used which shows the HOV lane and ordinary lane in separate two links.

Incidentally, the freeway infrastructure display unit 41 of the navigation system of the foregoing embodiment 1 or embodiment 2 can be configured in such a manner as to collectively display the freeway infrastructure to be displayed at each lane changeable section provided between the lanes.

In addition, although the foregoing embodiment 1 and embodiment 2 show the HOV lane and ordinary lane as an example of the two types of lanes, shifting between which is regulated, it is also applicable to a case where the two types of lanes are an express lane and an ordinary lane. Here, the term “express lane” refers to a specially provided lane that changes the direction of traffic according to days and hours, and regulates passing of a vehicle with only one passenger.

Furthermore, a combination of the foregoing embodiment 1 and embodiment 2 is also possible. For example, when the map data represents two types of lanes, shifting between which is regulated, such as an HOV lane and ordinary lane, in a single link, it executes the processing of the foregoing embodiment 1, and switches, when they are represented in two separate links, to the processing to the foregoing embodiment 2 to execute it.

Incidentally, the present invention can include free combinations of the embodiments or any variations within the spirit of the present invention.

### INDUSTRIAL APPLICABILITY

The present invention is applicable to an onboard navigation system that is required to appropriately inform a user of a freeway infrastructure accessible from a driving lane.

What is claimed is:

1. A navigation system comprising:
a map data acquiring unit for acquiring map data defining two types of lanes, shifting between which is regulated, in a single link;
a driving link deciding unit for identifying a link of a driving lane of a vehicle according to the map data acquired by the map data acquiring unit and according to position information about the vehicle;
a freeway infrastructure acquiring unit for acquiring, from node information of the map data freeway infrastructure data indicating a freeway infrastructure which is accessible by the vehicle from the driving lane including the link identified by the driving link deciding unit;
a freeway infrastructure storage unit for storing the freeway infrastructure data acquired by the freeway infrastructure acquiring unit; and
a freeway infrastructure display unit for displaying the freeway infrastructure data stored in the freeway infrastructure storage unit.

2. The navigation system according to claim 1, wherein
the freeway infrastructure accessible from the driving lane of the vehicle includes a freeway infrastructure which belongs to the lane other than the driving line and exits within a prescribed distance from a lane changeable section provided between the lanes.

3. The navigation system according to claim 1, wherein
the freeway infrastructure accessible from the driving lane by the vehicle is a dedicated infrastructure of the lane.

4. The navigation system according to claim 1, further comprising:
a freeway infrastructure redundancy deciding unit for deciding on whether a plurality pieces of the freeway infrastructure data containing the same accompanying infrastructure are present in the freeway infrastructure data stored in the freeway infrastructure storage unit, and for deleting, if the plurality pieces of the freeway infrastructure data containing the same accompanying infrastructure are present, the plurality pieces of the freeway infrastructure data except one of them.

5. The navigation system according to claim 1, wherein
the freeway infrastructure display unit displays the freeway infrastructure with additional information indicating the lane that enables access to the freeway infrastructure.

6. The navigation system according to claim 1, wherein
the two types of lanes, shifting between which is regulated, are an HOV lane and an ordinary lane, or an express lane and an ordinary lane.

7. The navigation system according to claim 2, wherein
the freeway infrastructure display unit displays freeway infrastructure, which are accessible from the other lane and are a subject to be displayed, collectively for each lane changeable section provided between the lanes.

8. A navigation system comprising:
a map data acquiring unit for acquiring map data defining two types of lanes, shifting between which is regulated, in two links;
a driving link deciding unit for identifying a link of a driving lane of a vehicle according to the map data acquired by the map data acquiring unit and according to position information about the vehicle;
a freeway infrastructure acquiring unit for acquiring, from node information of the map data, freeway infrastructure data indicating a freeway infrastructure which is accessible by the vehicle from the driving lane including the link identified by the driving link deciding unit, and freeway infrastructure data indicating a freeway infrastructure accessible from the lane other than the driving lane of the vehicle;
a freeway infrastructure storage unit for storing the freeway infrastructure data acquired by the freeway infrastructure acquiring unit; and
a freeway infrastructure display unit for displaying the freeway infrastructure data stored in the freeway infrastructure storage unit.

9. The navigation system according to claim 8, further comprising:
a freeway infrastructure redundancy deciding unit for deciding on whether a plurality pieces of the freeway infrastructure data containing the same accompanying infrastructure are present in the freeway infrastructure data stored in the freeway infrastructure storage unit, and for deleting, if the plurality pieces of the freeway infrastructure data containing the same accompanying infrastructure are present, the plurality pieces of the freeway infrastructure data except one of them.

10. The navigation system according to claim 8, wherein
the freeway infrastructure which is accessible from the other lane and is acquired by the freeway infrastructure acquiring unit includes a freeway infrastructure which belongs to the lane other than the driving line and exits within a prescribed distance from a lane changeable section provided between the lanes.

11. The navigation system according to claim 8, wherein
the freeway infrastructure display unit displays the freeway infrastructure with additional information indicating the lane that enables access to the freeway infrastructure.

12. The navigation system according to claim 8, wherein
the two types of lanes, shifting between which is regulated, are an HOV lane and an ordinary lane, or an express lane and an ordinary lane.

13. The navigation system according to claim 10, wherein
the freeway infrastructure display unit displays freeway infrastructure, which is accessible from the other lane and is a subject to be displayed, collectively for each lane changeable section provided between the lanes.
